(19) United States
(12) Patent Application Publication
(10) Pub. No.: US 2013/0130747 A1
(43) Pub. Date: May 23, 2013

(54) Communications Apparatus

(71) Applicant: Ian APPLETON, Letchworth (GB)

(72) Inventor: Ian APPLETON, Letchworth (GB)

(73) Assignee: Cambridge Silicon Radio Limited, Cambridge (GB)

(21) Appl. No.: 13/300,200

(22) Filed: Nov. 18, 2011

(51) Int. Cl. H04W 68/00

(52) U.S. Cl. 455/567

(57) ABSTRACT

A communications apparatus which operates using a multi-layer protocol stack, the communications apparatus comprising an application processor and a communications processor, wherein the communications processor is configured to handle all functionality related to paging of the communications apparatus without intervention from the application processor.

The present invention relates to a communications apparatus.

It is common for communications apparatus such as mobile telephone handsets to employ two separate processors, an application processor which handles applications which may be run on the handset and a dedicated communications processor for handling physical communications functions of the handset, such as transmitting and receiving signals containing data.

Many communications systems use a multi-layer protocol stack to manage the transfer and processing of data. For example, the 3GPP standard uses a multi-layer stack, in which layer 1 (the lowermost layer) is responsible for hardware control, including transmitting and receiving data. Layers 2 and 3 are responsible for configuring data to be transmitted, for example by constructing frames for data transmission which may include headers, checksum bits and the like in addition to the data to be transmitted. Above layer 3 there are applications which deal with functions related to a user interface of the handset and the like.

Typically, the communications processor of a mobile telephone handset handles the layer 1-3 functionality, whilst the application processor handles the application functionality. To minimise power consumption in an idle mode of the handset it is desirable for the application processor to enter a stand-by mode when no application functionality is required. A difficulty with this approach, however, is that paging messages which are periodically received by the communications processor must be passed to the application processor to decode. This requires the application processor to exit the stand-by mode, which increases the power consumption of the handset.

According to a first aspect of the present invention, there is provided a communications apparatus which operates using a multi-layer protocol stack, the communications apparatus comprising an application processor and a communications processor, wherein the communications processor is configured to handle all functionality related to paging of the communications apparatus without intervention from the application processor.

By confining handling of paging of the communications apparatus to the communications processor in this way, paging messages do not need to be passed from the communications processor to the application processor. This can bring about power savings in the communications apparatus, as the application processor can be deactivated or left in a stand-by mode in which less power is consumed when not in use, and need not be activated to handle paging messages.

The communications processor may be configured to implement functionality related to lower layers of the multi-layer stack and the application processor may be configured to implement functionality related to upper layers of the multi-layer protocol stack.

The communications processor may be configured to implement functionality related to layers 1 to 3 of the multi-layer stack.

The communications processor may be configured such that all functionality related to paging of the communications apparatus is implemented in a single layer of the multi-layer protocol stack.

The layer may be a physical layer of the multi-layer protocol stack.

A software module may be associated with the layer of the protocol stack, which software module is configured to handle at least part of the paging of the communications apparatus.

Embodiments of the invention will now be described, strictly by way of example only, with reference to the accompanying drawings, of which

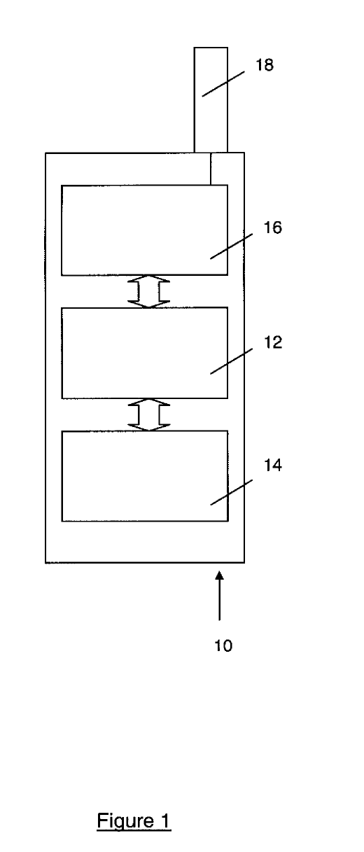

FIG. 1 is a schematic representation of a communications apparatus, such as a mobile telephone handset; and

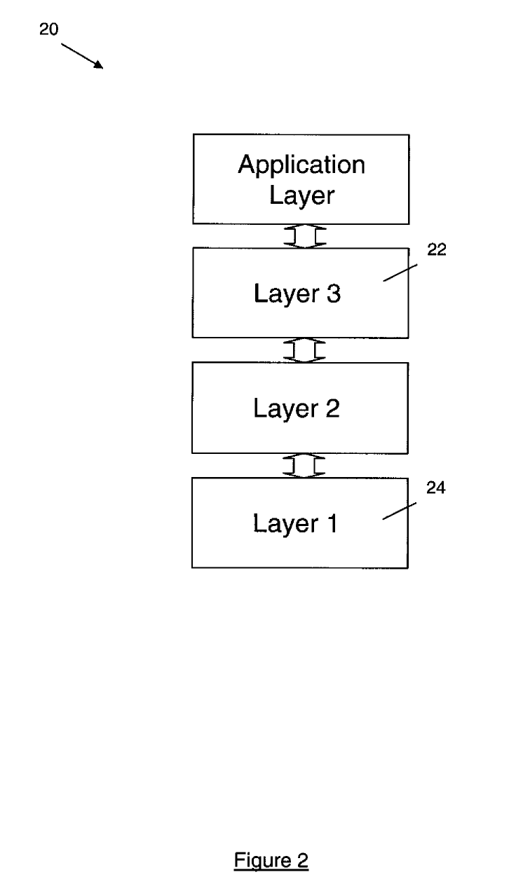

FIG. 2 is a schematic representation of a protocol stack used by the communications apparatus of FIG. 1.

FIG. 1 is a schematic representation of a communications apparatus, in this example a mobile telephone handset, which is shown generally at 10. The handset 10 comprises an application processor 12, which, in this example, is provided as a single integrated circuit (IC), although it may be provided in a combined package with a communications processor 16, and handles the operation of applications, such as an operating system, which run on the handset 10. The application processor 12 has an associated memory 14, which may be provided as one or more separate ICs, but is preferably provided as an integral part of the application processor IC.

A dedicated communications processor 16 is provided, in this example as a separate IC, although it may be provided in a combined package with the application processor 12, and is responsible for handling functions of the handset 10 related to transmitting and receiving data through a propagation channel. The communications processor 16 is connected to one or more antennae 18 of the handset 10 to transmit and receive appropriate signals.

In this example, the handset 10 is compliant with the 3GPP standard, and operates using a multi-layer protocol stack, as is illustrated generally at 20 in FIG. 2. However, it will be appreciated that other types of protocol stacks may be employed for managing data transfer between different functional elements of the handset 10. The multi-layer protocol stack will be familiar to those skilled in the art, and thus only those parts which are relevant to the present invention will be described in detail here.

The lowermost layer 22 (layer 1) of the protocol stack is known as the physical layer, and this layer deals with interactions with the physical medium (i.e. the air interface) over which data is transmitted and received by the handset 10. Thus, functions such as modulation, demodulation, coding, error correction and transmission of signals are performed in this layer. These functions are carried out by the communications processor 16, which, in the exemplary case of a transmission, receives data which has been processed in the higher layers of the protocol stack by the application processor 12 and applies appropriate coding and modulation before transmitting a signal comprising the coded and modulated data. When a signal is received, the communications processor 16 demodulates and decodes the received signal and passes the raw data carried by the signal up the protocol stack 20 to the application processor 12 for further processing.

Layer 3, which is illustrated at 24 in FIG. 2, is known as the network layer or the signalling layer, and deals with the connection and switching of communications links. The functionality of this layer is implemented in the communications processor 16 of the handset 10.

An advantage of the arrangement shown in FIG. 1, in which there is a dedicated communications processor 16 which is separate from the application processor 12 is that when the application processor 12 is not required, it can be switched off, or put into a stand-by mode, so as to reduce power consumption. However, a difficulty arises in handsets using this arrangement, in that the application processor 12 must be “woken up” every time a paging message is received from a network serving the handset 10, as the communications processor 16 is not able to handle such messages on its own.

The network serving the handset 10 periodically broadcasts paging messages to handsets on that network to inform the handsets of incoming calls, text messages and the like. These paging messages contain, amongst other data, an identifier, which must be checked by the handset 10 against its own identifier, to assess whether the paging message was intended for the handset 10, or for another device being served by the network.

When a paging message is received by the handset 10, the communications processor 16 demodulates and decodes the received signal, before passing the data contained in the received signal, including the identifier, up the protocol stack 20 to the application layer, which is implemented by the application processor 12. The application processor 12 compares the identifier with an identifier of the handset 10, and if the two identifiers match, a signal is transmitted to the network in response to the paging message. A disadvantage of this approach, as explained above, is that the application processor 12 must exit its stand-by mode every time a paging message is received. As paging messages are broadcast regularly by the network, the application processor 12 must exit its stand-by mode regularly, which limits the amount of power saved.

In a communications apparatus such as a handset 10 according to the present invention, the communications processor 16 is configured to handle all functionality associated with paging of the handset 10 without intervention from the application processor 12. Thus, on receiving a paging message from a network serving the handset 10, the communications processor 16 demodulates and decodes the received signal. The identifier is extracted from the data contained in the received signal by the communications processor 16 and verified by the communications processor 16, by comparing it to the identifier of the handset 10, which may be stored in the memory 14, or otherwise known to the communications processor 16.

If the identifier contained in the received signal corresponds to the identifier of the handset 10, the message is intended for the handset 10, and thus the communications processor causes the application processor 12 to be activated, so that it can handle the incoming call, text message or the like. If the identifier contained in the received signal does not correspond to that of the handset 10, the application processor 12 is allowed to remain in its stand-by mode.

By confining the handling of paging messages to the communications processor 16 in this way, the application processor 12 need not be activated as frequently as in prior art systems, which gives rise to power savings over such systems. However, when it is determined that a paging message is intended for the handset 10, the application processor 12 can be activated in good time to handle the incoming call, text message or the like. Thus, there is no reduction in the functionality of the handset 10.

In a particular embodiment of the invention, the functions of the handset 10 which relate to paging, for example the verification of the identifier transmitted by the network in the paging message, are transferred to the physical layer 22 (layer 1) of the protocol stack. As the functionality of this layer is implemented by the communications processor 16, paging messages can be handled without causing the application processor 12 to exit its stand-by mode. It will be appreciated, however, that only functions related to the handling of paging messages need be transferred to the physical layer 22 (layer 1), and indeed if additional functions were moved to the physical layer 22, the communications processor 16 could become unnecessarily complex.

The functions which relate to paging of the handset 10 may be built into the physical layer 22 of the protocol stack 20, or there may be a separate software module associated with the physical layer 22, which software module can be accessed and controlled by the physical layer 22 to implement the functions relating to paging of the handset 10. Using a separate software module which is associated with the physical layer 22 rather than implementing the functions relating to paging of the handset 10 directly in the physical layer 22 avoids over-complicating the physical layer 22.

The embodiments described above use separate application and communications processors, but the invention may be equally applicable to systems having different architectures, such as a system in which all of the functionality of the application and communications processors is implemented in a single IC. In this example, a handset 10 may comprise a single application/communications processor having a plurality of functional units which can each be switched off or put into a stand-by when not in use, so as to reduce power consumption. By implementing functions relating to paging in a functional unit which handles the physical layer 22 of such a processor, other functional units, such as those which handle the network layer 24, need not be switched on or exit their stand-by mode every time a paging message is received, thus reducing the power consumption of the handset 10.

Similarly, in a system comprising a single processor which accesses external memory, by implementing functions relating to paging of the handset in the physical layer 22 of the processor, it may be possible to reduce the amount of external memory access that must be performed. For example, the system may include memory elements associated with the physical layer 22 and the application layer, and by implementing the functions related to paging of the handset in the physical layer 22, it is not necessary for the memory element associated with the application layer to be accessed in response to a paging message. Thus, this memory element may remain switched off or in stand-by mode, reducing the power consumption of the handset 10.

1. A communications apparatus which operates using a multi-layer protocol stack, the communications apparatus comprising an application processor and a communications processor, wherein the communications processor is configured to handle all functionality related to paging of the communications apparatus without intervention from the application processor.

2. A communications apparatus according to claim 1 wherein the communications processor is configured to implement functionality related to lower layers of the multi-layer stack and the application processor is configured to implement functionality related to upper layers of the multi-layer protocol stack.

3. A communications apparatus according to claim 2 wherein the communications processor is configured to implement functionality related to layers 1 to 3 of the multi-layer stack.

4. A communications apparatus according to claim 1 wherein the communications processor is configured such that all functionality related to paging of the communications apparatus is implemented in a single layer of the multi-layer protocol stack.

5. A communications apparatus according to claim 4 wherein the layer is a physical layer of the multi-layer protocol stack.

6. A communications apparatus according to claim 4 wherein a software module is associated with the layer of the protocol stack, which software module is configured to handle at least part of the paging of the communications apparatus.
